(19) United States
(12) Patent Application Publication
(10) Pub. No.: US 2020/0262192 A1
(43) Pub. Date: Aug. 20, 2020

(54) A LITHOGRAPHIC PRINTING PLATE PRECURSOR

(71) Applicant: AGFA NV, Mortsel (BE)

(72) Inventors: Tim DESMET, Mortsel (BE); Johan LOCCUFIER, Mortsel (BE)

(21) Appl. No.: 15/776,797

(22) PCT Filed: Nov. 14, 2016
(86) PCT No.: PCT/EP2016/077546

§ 371 Date: May 17, 2018

(30) Foreign Application Priority Data
Nov. 20, 2015 (EP) 15195567.1

(51) Int. Cl. B41C 1/10; B41N 1/14

(52) U.S. Cl. CPC B41C 1/1091; B41C 2210/02; B41N 1/14

(57) ABSTRACT

A positive-working lithographic printing plate precursor includes on a support having a hydrophilic surface or which is provided with a hydrophilic layer, a heat and/or light-sensitive coating including an infrared absorbing agent and a binder including a monomeric unit including an oxalylamide moiety and a monomeric unit including a solubility enhancing group.

### CROSS REFERENCE TO RELATED APPLICATIONS

This application is a 371 National Stage Application of PCT/EP2016/077546, filed Nov. 14, 2016. This application claims the benefit of European Application No. 15195567.1, filed Nov. 20, 2015, which is incorporated by reference herein in its entirety.

### BACKGROUND OF THE INVENTION

### 1. Field of the Invention

The present invention relates to a positive-working lithographic printing plate precursor comprising a novel binder.

### 2. Description of the Related Art

Lithographic printing presses use a so-called printing master such as a printing plate which is mounted on a cylinder of the printing press. The master carries a lithographic image on its surface and a print is obtained by applying ink to said image and then transferring the ink from the master onto a receiver material, which is typically paper. In conventional, so-called “wet” lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the image-wise exposure and processing of an imaging material called plate precursor. In addition to the well-known photosensitive, so-called pre-sensitized plate precursors, which are suitable for UV contact exposure through a film mask, also heat-sensitive printing plate precursors have become very popular in the late 1990s. Such thermal materials offer the advantage of daylight stability and are especially used in the so-called computer-to-plate method wherein the plate precursor is directly exposed, i.e. without the use of a film mask. The material is exposed to heat or to infrared light and the generated heat triggers a (physico-)chemical process, such as ablation, polymerization, insolubilization by crosslinking of a polymer, heat-induced solubilization or particle coagulation of a thermoplastic polymer latex.

The most popular thermal plates form an image by a heat-induced solubility difference in an alkaline developer between exposed and non-exposed areas of the coating. The coating typically comprises an oleophilic binder, e.g. a phenolic resin, of which the rate of dissolution in the alkaline developer is either reduced (negative working) or increased (positive working) by the image-wise exposure. During processing, the solubility differential leads to the removal of the non-image (non-printing) areas of the coating, thereby revealing the hydrophilic support, while the image (printing) areas of the coating remain on the support. Typical examples of such plates are described in e.g. EP-A 625728, 823327, 825927, 864420, 894622 and 901902. Negative working embodiments of such thermal materials often require a pre-heat step between exposure and development as described in e.g. EP-625,728.

The quality of the prints is determined by the lithographic properties of the hydrophobic image areas and the hydrophilic non-image areas: the greater the difference between these two properties the better the quality of the plate. A measure of this difference in properties is the so-called lithographic contrast between image and non-image parts. At the same time, the lithographic printing plate should be sufficiently resistent against application of a variety of treating liquids or in other words, should have a high chemical resistance. Indeed, before, during and after the printing step, a lithographic printing plate is in general exposed to various liquids such as for example ink and/or fountain solutions or plate treating liquids for further improving the lithographic properties of the image and non-image areas. In the graphic arts industry, there is an evolution towards the use of more abrasive inks, fountain solutions and/or plate cleaners. These harsh printing conditions, especially occuring on web presses, not only impose more stringent demands on the chemical resistance of the printing plates towards pressroom chemicals and inks but also reduce their press life.

The current state-of-the-art in thermal plates is mainly focussed on novolac binder based printing plates and/or poly(vinyl acetal) or poly(ethylene vinyl acetal) binder based printing plates.

Positive thermal plates are typically used in very high image quality printing applications (i.e. books, magazines) and require processing in high pH (>12) developers whereby the consumption of chemicals is substantial. Indeed, the working mechanism of positive-working thermal plates based on a solubility difference of the coating including a binder having e.g. phenolic groups is based on the following sequence:
supramolecular organization of the binder by formation of hydrogen bonds;
disruption of this organization upon exposure with heat and/or light making the phenolic groups accessible for deprotonation by a highly alkaline developer;
followed by a faster dissolution kinetic in terms of for example deprotonation and penetration of the exposed parts.

Phenolic groups typically have, as single molecules, a pKa around 10. In order to have a complete and fast deprotonation of such groups, a solution with a pH of at least 11 would be needed. In coatings of printing plates a polymer matrix is formed due to hydrogen bonds between the phenolic groups, resulting in a higher pKa of the bonded phenol groups. As a consequence, in order to obtain high quality prints, developers having a pH of at least 12 are needed for developing current positive-working printing plates based on phenolic resins. However, in view of the growing demand for more environmentally friendly processes, there is an urgent need for more sustainable thermal positive printing plate systems. In addition, due to the high alkalinity of the developer which may attack the lithographic image, a rinsing and gumming step is usually performed demanding a high water consumption and making the whole process less straightforward and prone to problems. Therefore, a simplified workflow where the processing and gumming step are carried out in one single step using a low-pH finisher would be advantageous from both a environmental and economic point point of view. Such methods however can only be used for specially designed plates, which have lithographic coatings that are sufficiently soluble or dispersible in the gum solution so that a good clean-out (complete removal of the coating in the non-printing areas) is obtained.

For example, EP 1 342 568 and WO 2005/111727 describe a method which involves the use of a gum solution as developer whereby the plate is developed and gummed in a single step. WO 02/053627, US 04/0023155 and US 02/160299 disclose a positive working lithographic printing plate precursor comprising a thermally sensitive supramolecular polymer including a phenolic, acrylic, polyester or polyurethane resin substituted with one or more groups, such as an isocytosine group, capable of forming two or more hydrogen bonds. Upon heating of the imaging element, the modified polymer becomes soluble in an alkaline developer.

EP 1 705 003 discloses a heat-sensitive lithographic printing plate which requires no wet processing step and includes a coating comprising a polymer modified with at least two groups which can form four hydrogen bonds.

The use of oxalylamide-based monomers and/or compounds in printing plates has been described for negative-working photopolymer plates in WO2014/198820 and WO2014/198823. Such negative-working, photopolymer printing plates are based on a polymerization reaction of monomers upon exposure to light and thus have a completely different working mechanism.

### SUMMARY OF THE INVENTION

Preferred embodiments of the present invention provide a positive-working lithographic printing plate precursor which provides a printing plate with an excellent lithographic quality after processing in more environmentally acceptable developer solutions and/or in single step developers which combine developing and gumming.

The lithographic quality of the printing plate is determined by the difference between the hydrophilicity of the non-image areas and the hydrophobicity of the image areas—herein further referred to as the lithographic contrast. Areas having hydrophilic properties means areas having a higher affinity for an aqueous solution than for an oleophilic ink; areas having hydrophobic properties means areas having a higher affinity for an oleophilic ink than for an aqueous solution.

This is realized by a lithographic printing plate precursor including a novel binder comprising oxalylamide moieties, i.e. a lithographic printing plate precursor, which comprises on a support having a hydrophilic surface or which is provided with a hydrophilic layer, a heat and/or light-sensitive coating including an infrared absorbing agent and a binder including a monomeric unit including an oxalylamide moiety and a monomeric unit including a group capable of being deprotonated in an aqueous solution.

Other features, elements, steps, characteristics and advantages of the present invention will become more apparent from the following detailed description. Specific embodiments of the invention are also defined below.

### DETAILED DESCRIPTION OF THE PREFERRED EMBODIMENTS

A lithographic printing plate precursor according to the present invention comprises a heat and/or light sensitive coating and is positive-working, i.e. after exposure and development the exposed areas of the coating are removed from the support and define hydrophilic (non-printing) areas, whereas the unexposed coating is not removed from the support and defines oleophilic (printing) areas.

The heat and/or light sensitive coating includes a novel binder comprising a monomeric unit including an oxalylamide moiety. This binder is further also referred to as “oxalylamido binder”. The working-mechanism of the printing plate precursor is based on disruption of the oxalylamide supramolecular organization formed through hydrogen bonds.

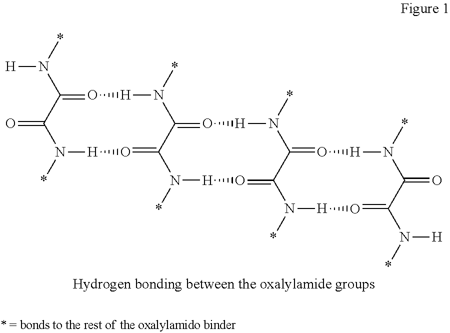

The pKa of the oxalylamide functionality is, based on calculation, believed to be around 20, and therefore deprotonation of these groups is not possible in aqueous media even at a high pH (for example above 11). To achieve developability, the oxalylamido binder of the present invention contains a monomeric unit including a group which is able to be deprotonated in an aqueous solution; also referred to as solubility enhancing group. This mechanism wherein image formation is mainly occasioned by the oxalylamide moieties and the dissolution behaviour is mainly occasioned by the solubility enhancing groups should allow the production of low pH (preferably below 11) processable printing plates.

Upon exposure with light and/or heat, it is believed that the intramolecular hydrogen bridges located on the oxalylamido binder will at least partially be disrupted and the cohesion of the supramolecular organisation will be reduced or even get lost. Upon subsequent development, the solubility enhancing groups may become deprotonated making the binder and/or coating soluble in water-based developer solutions in the exposed areas. By selecting solubility enhancing groups which have a relatively low pKa such as for example carboxylic acid groups, fast deprotonation may occur at relatively low pH (7-9) leading to improved dissolution behaviour of the binder and/or coating. The ratio between the oxalylamide moieties and the solubility enhancing groups, and/or the kind of solubility enhancing group, influence the solubility of the oxalylamido binder and can be optimised be the skilled person.

Preferably the oxalylamido binder contains at least 15 mol % monomeric units including an oxalylamide moiety, more preferably at least 20 mol %, and most preferably at least 25 mol %. Alternatively, the binder preferably contains between 55 mol % and 95 mol % of the oxalylamide moiety.

The monomeric unit including an oxalylamide moiety is preferably presented by structure I:

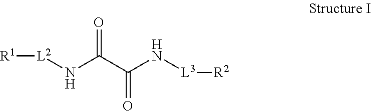

wherein R¹ represents a group including a free radical polymerisable group;
R² represents a terminal group; and
L² and L³ independently represent a divalent linking group.

The free radical polymerisable group is preferably represented by an ethylenical unsaturated group. The ethylenical unsaturated group preferably represents an optionally substituted acrylate, methacrylate, acrylamide, methacrylamide, maleimide, styryl or vinyl group.

An acrylate and methacrylate group are particularly preferred. The optional substituents may represent a halogen such as a fluorine, chlorine, bromine or iodine atom, an alkoxy group such as a methoxy or ethoxy group or an alkyl group such as a methyl, ethyl, propyl or isopropyl group.

The terminal group R² is preferably represented by hydrogen, an optionally substituted alkyl or cycloalkyl group, an optionally substituted aryl group, an optionally substituted aralkyl group or an optionally substituted heteroaryl group.

The divalent linking groups L² and L³ are preferably independently selected from an optionally substituted alkylene, cycloalkylene, arylene, or heteroarylene, —O—, —CO—, —CO—O—, —O—CO—, —CO—NH—, —NH—CO—, —NH—CO—O—, —O—CO—NH—, —NH—CO—NH—, —NH—CS—NH—, —CO—NR′—, —NR″—CO—, —NH—CS—NH—, —SO—, —SO₂—, —SO₂—NH—, —H—SO₂—, —CH═N—, —NH—NH—, —N⁺(CH₃)₂—, —S—, —S—S—, and/or combinations thereof, wherein R′ and R″ each independently represent an optionally substituted alkyl, aryl, or heteroaryl. The substituents optionally present on the alkylene, the cyloalkylene, the arylene or the heteroarylene group may be represented by an alkyl group such as a methyl, ethyl, propyl or isopropyl group, substituents including for example oxygen or sulfur; a halogen such as a fluorine, chlorine, bromine or iodine atom; a hydroxyl group; an amino group; an alkoxy group such as a methoxy or ethoxy group or a (di)alkylamino group.

More preferably, the divalent linking groups L² and L³ independently represent a divalent aliphatic group including straight or branched carbon chain(s) or alicyclic, non-aromatic ring(s). Optionally the aliphatic linking group may contain substituents including for example oxygen or sulfur; alkyl groups such as a methyl, ethyl, propyl or isopropyl group and halogens such as a fluorine, chlorine, bromine or iodine atom.

Most preferably, linking groups L² and L³ independently represent an optionally substituted alkylene or cycloalkylene group. The substituents optionally present on the alkylene or cycloalkylene group may be represented by an alkyl group such as a methyl, ethyl, propyl or isopropyl group or a halogen such as a fluorine, chlorine, bromine or iodine atom.

The solubility enhancing group present in the oxalylamido binder preferably has a pKa below 10, more preferably below 9 and most preferably below 8. A suitable solubility enhancing group may represent for example a carboxylic group, a sulfonic acid group, an imide group, a phosphonic acid group, a sulfuric acid mono ester group and/or a phosphoric acid mono or di ester. Preferably the oxalylamido resin contains at least 5 mol % of a monomeric unit including a solubility enhancing group; more preferably at least 10 mol %, and most preferably at least 20 mol %. Alternatively, the oxalylamido resin preferably contains between 5 and 50 mol % of a monomeric unit including a solubility enhancing group, more preferably between 10 and 45 mol %, and most preferably between 20 and 40 mol %.

The ratio between the oxalylamide moieties and the solubility enhancing groups determines the properties of the oxalylamido binder. The binder preferably contains between 55 mol % and 95 mol % of the monomeric unit including an oxalylamide moiety and between 5 mol % and 50 mol % of the monomeric unit including a solubility enhancing group. The ratio between the oxalylamide moiety and the solubility enhancing group and/or between both types of monomeric units can be optimised by the skilled person in order to obtain an optimal heat-induced solubility difference between exposed and non-exposed areas of the coating in a specific developer solution. In other words, depending on the type of developer(mild or more aggressive), the ratio between both monomeric units can be modified by the skilled person in order to obtain an optimal lithographic quality.

Without being limited thereto, typical generic structures of binders according to the present invention represented by their two essential monomers—making abstraction of their molar ratio in the polymeric binder—are given below.

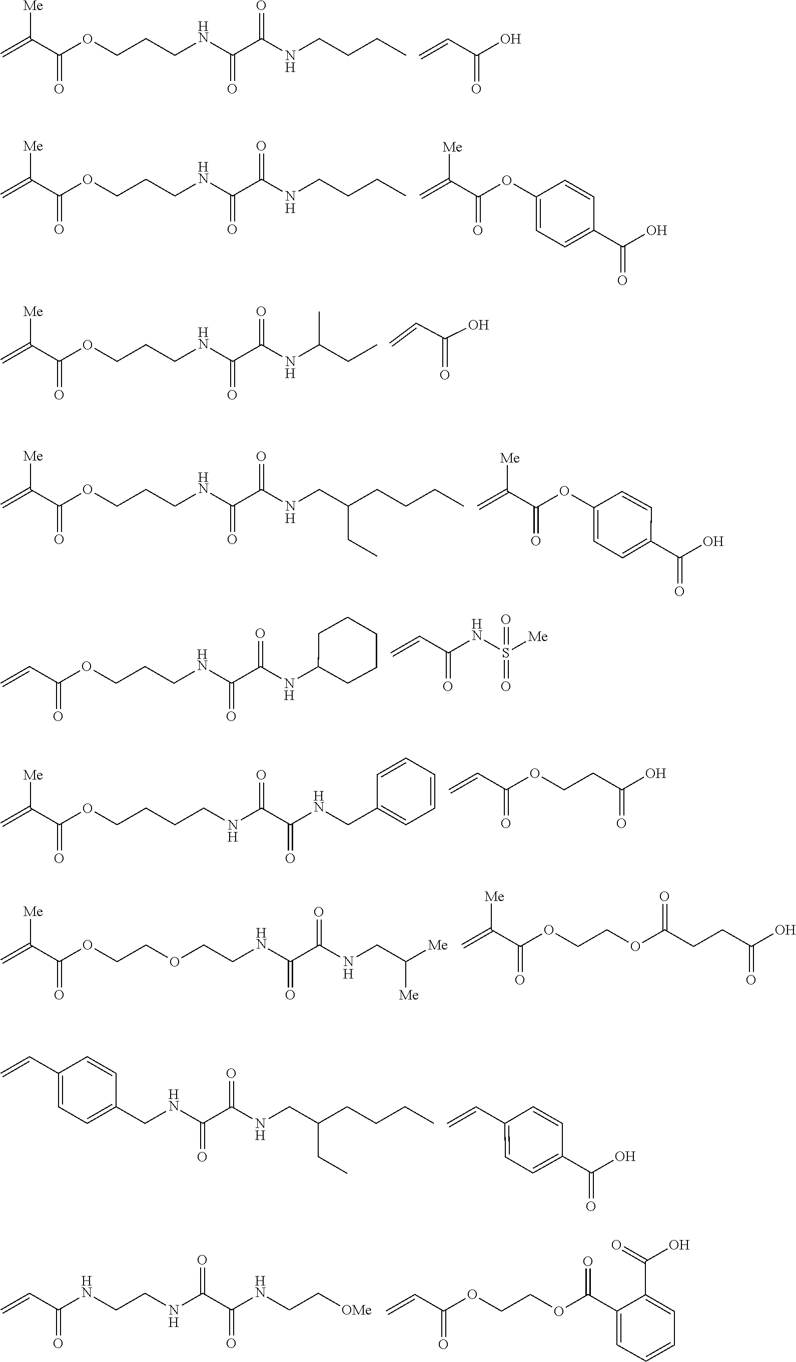

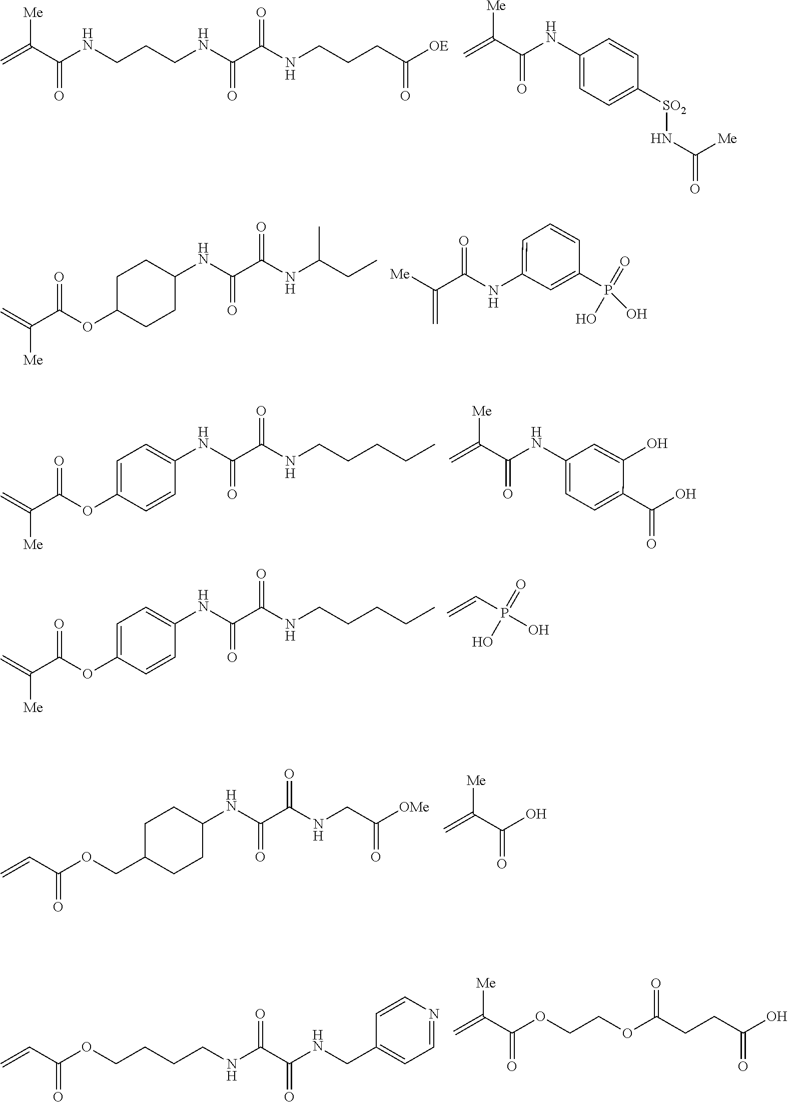

The oxalylamido binder according to the present invention may further comprise one or more other monomeric units, preferably selected from an acrylate or methacrylate e.g. an alkyl or aryl (meth)acrylate such as methyl (meth)acrylate, ethyl (meth)acrylate, butyl (meth)acrylate, benzyl (meth) acrylate, 2-phenylethyl (meth) acrylate, hydroxylethyl (meth)acrylate, phenyl (meth)acrylate or N-(4-metylpyridyl) (meth)acrylate; a (meth)acrylamide e.g. (meth)acrylamide or a N-alkyl or N-aryl (meth)acrylamide such as N-methyl (meth)acrylamide, N-ethyl (meth)acrylamide, N-phenyl (meth) acrylamide, N-benzyl (meth) acrylamide, N-methylol (meth)acrylamide, N-(4-hydroxyphenyl) (meth)acrylamide; (meth)acrylonitrile; styrene; a substituted styrene such as 2-, 3- or 4-hydroxy-styrene, 4-carboxy-styrene ester; a vinylpyridine such as 2-vinylpyridine, 3-vinylpyridine, 4-vinylpyridine; a substituted vinylpyridine such as 4-methyl-2-vinylpyridine; vinyl acetate, optionally the copolymerised vinyl acetate monomeric units are at least partially hydrolysed, forming an alcohol group, and/or at least partially reacted by an aldehyde compound such as formaldehyde or butyraldehyde, forming an acetal or butyral group; vinyl alcohol; vinyl nitrile; vinyl acetal; vinyl butyral; a vinyl ether such as methyl vinyl ether; vinyl amide; a N-alkyl vinyl amide such as N-methyl vinyl amide, caprolactame, vinyl pyrrolydone; maleic anhydride, a maleimide e.g. maleimide or a N-alkyl or N-aryl maleimide such as N-benzyl maleimide.

The binder according to the present invention preferably has a molecular weight which is sufficiently high in order to have film forming properties.

The amount of binder according to the present invention in the coating is preferably above 70% wt; more preferably above 75% wt and most preferably above 80% wt; relative to the total weight of all ingredients in the coating.

The coating may include one layer including the oxalylamido binder, also referred to as the “thermal responsive” layer. The coating may contain additional layer(s) such as for example, a chemical resistant layer and/or an adhesion-improving layer. These layers may be located between the thermal responsive layer including the oxalylamido binder and the aluminium support. The chemical resistant layer improves the press life of the printing plate. Preferably, the oxalylamido binder is present in the thermal responsive layer but may be present in both the chemical resistant layer and the thermal responsive layer. The chemical resistant layer preferably includes a binder selected from a polyester resin, a polyamide resin, an epoxy resin, an acrylic resin, a methacrylic resin, a styrene based resin, a polyurethane resin or a polyurea resin. The binder may have one or more functional groups. The functional group(s) can be selected from the list of
(i) a sulfonamide group such as —NR—SO₂—, —SO₂—NR— or —SO₂—N′R″ wherein R and R′ independently represent hydrogen or an optionally substituted hydrocarbon group such as an optionally substituted alkyl, aryl or heteroaryl group; more details concerning these polymers can be found in EP 2 159 049;
(ii) a sulfonamide group including an acid hydrogen atom such as —SO₂—NH—CO— or —SO₂—NH—SO₂— as for example disclosed in U.S. Pat. No. 6,573,022; suitable examples of these compounds include for example N-(p-toluenesulfonyl) methacrylamide and N-(p-toluenesulfonyl) acrylamide;
(iii) an urea group such as —NH—CO—NH—, more details concerning these polymers can be found in WO 01/96119;
(iv) a star polymer in which at least three polymer chains are bonded to a core as described in EP 2 497 639;
(v) a carboxylic acid group;
(vi) a nitrile group;
(vii) a sulfonic acid group; and/or
(viii) a phosphoric acid group.

(Co)polymers including a sulfonamide group are preferred. Sulfonamide (co)polymers are preferably high molecular weight compounds prepared by homopolymerization of monomers containing at least one sulfonamide group or by copolymerization of such monomers and other polymerizable monomers. Preferably, in the embodiment where the oxalylamido binder of the present invention is present in thermal responsive layer, the copolymer comprising at least one sulfonamide group is present in the first layer located between the layer including the oxalylamido binder and the hydrophilic support.

Examples of monomers copolymerized with the monomers containing at least one sulfonamide group include monomers as disclosed in EP 1 262 318, EP 1 275 498, EP 909 657, EP 1 120 246, EP 894 622, U.S. Pat. No. 5,141,838, EP 1 545 878 and EP 1 400 351. Monomers such as alkyl or aryl (meth)acrylate such as methyl (meth)acrylate, ethyl (meth)acrylate, butyl (meth)acrylate, benzyl (meth) acrylate, 2-phenylethyl (meth) acrylate, hydroxyethyl (meth) acrylate, phenyl (meth) acrylate; (meth)acrylic acid; (meth)acrylamide; a N-alkyl or N-aryl (meth)acrylamide such as N-methyl (meth)acrylamide, N-ethyl (meth) acrylamide, N-phenyl (meth) acrylamide, N-benzyl (meth)acrylamide, N-methylol (meth)acrylamide, N-(4-hydroxyphenyl) (meth) acrylamide, N-(4-methylpyridyl) (meth)acrylate; (meth)acrylonitrile; styrene; a substituted styrene such as 2-, 3- or 4-hydroxy-styrene, 4-benzoic acid-styrene; a vinylpyridine such as 2-vinylpyridine, 3-vinylpyridine, 4-vinylpyridine; a substituted vinylpyridine such as 4-methyl-2-vinylpyridine; vinyl acetate, optionally the copolymerised vinyl acetate monomeric units are at least partially hydrolysed, forming an alcohol group, and/or at least partially reacted by an aldehyde compound such as formaldehyde or butyraldehyde, forming an acetal or butyral group; vinyl alcohol; vinyl acetal; vinyl butyral; a vinyl ether such as methyl vinyl ether; vinyl amide; a N-alkyl vinyl amide such as N-methyl vinyl amide, N-vinyl caprolactame, vinyl pyrrolydone; maleimide; a N-alkyl or N-aryl maleimide such as N-benzyl maleimide, are preferred.

Suitable examples of sulfonamide (co)polymers and/or their method of preparation are disclosed in EP 933 682, EP 982 123, EP 1 072 432, WO 99/63407, EP 1 400 351 and EP 2 159 049. A highly preferred example of a sulfonamide (co)polymer is described in EP 2 047 988 A in [0044] to [0046].

Specific preferred examples of sulphonamide (co)polymers are polymers comprising N-(p-aminosulfonylphenyl) (meth) acrylamide, N-(m-aminosulfonylphenyl) (meth) acrylamide N-(o-aminosulfonylphenyl) (meth)acrylamide and or m-aminosulfonylphenyl (meth) acrylate.

(Co)polymers including an imide group are also preferred as a binder in the heat-sensitive coating. Specific examples include derivatives of methyl vinyl ether/maleic anhydride copolymers and derivatives of styrene/maleic anhydride copolymers, that contain an N-substituted cyclic imide monomeric units and/or N-substituted maleimides such as a N-phenylmaleimide monomeric unit and a N-benzyl-maleimide monomeric unit. Preferably, this copolymer is present in the first layer located between the layer including the oxalylamido binder and the hydrophilic support. This copolymer is preferably alkali soluble. Suitable examples are described EP 933 682, EP 894 622 A [0010] to [0033], EP 901 902, EP 0 982 123 A [007] to [0114], EP 1 072 432 A [0024] to [0043] and WO 99/63407 (page 4 line 13 to page 9 line 37).

Polycondensates and polymers having free phenolic hydroxyl groups, as obtained, for example, by reacting phenol, resorcinol, a cresol, a xylenol or a trimethylphenol with aldehydes, especially formaldehyde, or ketones, may also be added to the heat-sensitive coating. Condensates of sulfamoyl- or carbamoyl-substituted aromatics and aldehydes or ketones are also suitable. Polymers of bismethylol-substituted ureas, vinyl ethers, vinyl alcohols, vinyl acetals or vinylamides and polymers of phenylacrylates and copolymers of hydroxy-phenylmaleimides are likewise suitable. Furthermore, polymers having units of vinylaromatics or aryl (meth)acrylates may be mentioned, it being possible for each of these units also to have one or more carboxyl groups, phenolic hydroxyl groups, sulfamoyl groups or carbamoyl groups. Specific examples include polymers having units of 2-hydroxyphenyl (meth)acrylate, of 4-hydroxystyrene or of hydroxyphenylmaleimide. The polymers may additionally contain units of other monomers which have no acidic units. Such units include vinylaromatics, methyl (meth)acrylate, phenyl(meth)acrylate, benzyl (meth)acrylate, methacrylamide or acrylonitrile.

Optionally, the coating may further comprise one or more binders selected from hydrophilic binders such as homopolymers and copolymers of vinyl alcohol, (meth)acrylamide, methylol (meth)acrylamide, (meth)acrylic acid, hydroxyethyl (meth) acrylate, maleic anhydride/vinylmethylether copolymers, copolymers of (meth)acrylic acid or vinylalcohol with styrene sulphonic acid; hydrophobic binders such as phenolic resins (e.g. novolac, resoles or polyvinyl phenols); chemically modified phenolic resins or polymers containing a carboxyl group, a nitrile group or a maleimide group as described in DE 4 007 428, DE 4 027 301 and DE 4 445 820; polymers having an active imide group such as —SO₂—NH—CO—R^{h}, —SO₂—NH—SO₂—R^{h} or —CO—NH—SO₂—R^{h} wherein R^{h} represents an optionally substituted hydrocarbon group such as an optionally substituted alkyl, aryl, alkaryl, aralkyl or heteroaryl group; polymers comprising a N-benzyl-maleimide monomeric unit as described in EP 933 682, EP 894 622 (page 3 line 16 to page 6 line 30), EP 982 123 (page 3 line 56 to page 51 line 5), EP 1 072 432 (page 4 line 21 to page 10 line 29) and WO 99/63407 (page 4 line 13 to page 9 line 37); polymers having an acidic group which can be selected from polycondensates and polymers having free phenolic hydroxyl groups, as obtained, for example, by reacting phenol, resorcinol, a cresol, a xylenol or a trimethylphenol with aldehydes, especially formaldehyde, or ketones; condensates of sulfamoyl- or carbamoyl-substituted aromatics and aldehydes or ketones; polymers of bismethylol-substituted ureas, vinyl ethers, vinyl alcohols, vinyl acetals or vinylamides and polymers of phenylacrylates and copolymers of hydroxy-phenylmaleimides; polymers having units of vinylaromatics, N-aryl(meth)acrylamides or aryl (meth)acrylates containing optionally one or more carboxyl groups, phenolic hydroxyl groups, sulfamoyl groups or carbamoyl groups such as polymers having units of 2-hydroxyphenyl (meth)acrylate, of N-(4-hydroxyphenyl) (meth)acrylamide, of N-(4-sulfamoylphenyl)-(meth)acrylamide, of N-(4-hydroxy-3,5-dimethylbenzyl)-(meth)acrylamide, or 4-hydroxystyrene or of hydroxyphenylmaleimide; vinylaromatics, methyl (meth)acrylate, phenyl(meth)acrylate, benzyl (meth)acrylate, methacrylamide or acrylonitrile.

The dissolution behavior of the coating in the developer can be fine-tuned by optional solubility regulating components. More particularly, development accelerators and development inhibitors can be used. In the embodiment where the layer includes two layers or more, these ingredients are preferably added to the the thermal responsive layer.

Development accelerators are compounds which act as dissolution promoters because they are capable of increasing the dissolution rate of the coating. Developer resistance means, also called development inhibitors, are compounds which are capable of delaying the dissolution of the unexposed areas during processing. The dissolution inhibiting effect is preferably reversed by heating, so that the dissolution of the exposed areas is not substantially delayed and a large dissolution differential between exposed and unexposed areas can thereby be obtained. The compounds described in e.g. EP 823 327 and WO 97/39894 are believed to act as dissolution inhibitors due to interaction, e.g. by hydrogen bridge formation, with the alkali-soluble resin(s) in the coating. Inhibitors of this type typically comprise at least one hydrogen bridge forming group such as nitrogen atoms, onium groups, carbonyl (—CO—), sulfinyl (—SO—) or sulfonyl (—SO₂—) groups and a large hydrophobic moiety such as one or more aromatic rings. Some of the compounds mentioned below, e.g. infrared dyes such as cyanines and contrast dyes such as quaternized triarylmethane dyes can also act as a dissolution inhibitor.

Other suitable inhibitors improve the developer resistance because they delay the penetration of the aqueous alkaline developer into the coating. Such compounds can be present in the thermal responsive layer and/or in an optional second layer as described in e.g. EP 950 518, and/or in an optional development barrier layer on top of said layer as described in e.g. EP 864 420, EP 950 517, WO 99/21725 and WO 01/45958. In the latter embodiment, the solubility of the barrier layer in the developer or the penetrability of the barrier layer by the developer can be increased by exposure to heat or infrared light.

Preferred examples of inhibitors which delay the penetration of the aqueous alkaline developer into the coating include (i) polymeric materials which are insoluble in or impenetrable by the developer, (ii) bifunctional compounds such as surfactants comprising a polar group and a hydrophobic group such as a long chain hydrocarbon group, a poly- or oligosiloxane and/or a perfluorinated hydrocarbon group such as Megafac F-177, a perfluorinated surfactant available from Dainippon Ink & Chemicals, Inc., (iii) bifunctional block-copolymers comprising a polar block such as a poly- or oligo(alkylene oxide) and a hydrophobic block such as a long chain hydrocarbon group, a poly- or oligosiloxane and/or a perfluorinated hydrocarbon group such as Tego Glide 410, Tego Wet 265, Tego Protect 5001 or Silikophen P50/X, all commercially available from Tego Chemie, Essen, Germany.

The coating of the heat-sensitive printing plate precursors described above also contains an infrared light absorbing dye or pigment which may be present in the thermal responsive layer and/or in an optional other layer. Preferred IR absorbing dyes are cyanine dyes, merocyanine dyes, indoaniline dyes, oxonol dyes, pyrilium dyes and squarilium dyes. Examples of suitable IR dyes are described in e.g. EP-As 823327, 978376, 1029667, 1053868, 1093934; WO 97/39894 and 00/29214. A preferred compound is the following cyanine dye:

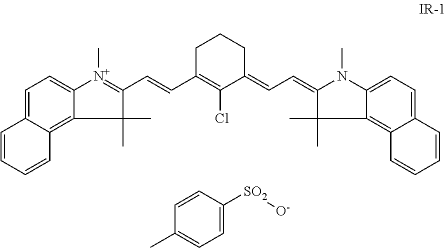 [SMILES: CN1/C(=C/C=C2\CCCC(/C=C/C3=[N+](C)c4ccc5ccccc5c4C3(C)C)=C2Cl)C(C)(C)c2c1ccc1ccccc21 ; Cc1ccc(S(=O)(=O)[O-])cc1]

The concentration of the IR-dye in the coating is preferably between 0.25 and 15.0% wt, more preferably between 0.5 and 10.0% wt, most preferably between 1.0 and 7.5% wt relative to the coating as a whole.

The coating may further comprise one or more colorant(s) such as dyes or pigments which provide a visible color to the coating and which remain in the coating at the image areas which are not removed during the processing step. Thereby a visible image is formed and examination of the lithographic image on the developed printing plate becomes feasible. Such dyes are often called contrast dyes or indicator dyes. Preferably, the dye has a blue color and an absorption maximum in the wavelength range between 600 nm and 750 nm. Typical examples of such contrast dyes are the amino-substituted tri- or diarylmethane dyes, e.g. crystal violet, methyl violet, victoria pure blue, flexoblau 630, basonylblau 640, auramine and malachite green. Also the dyes which are discussed in depth in EP-A 400,706 are suitable contrast dyes. Dyes which, combined with specific additives, only slightly color the coating but which become intensively colored after exposure, as described in for example WO2006/005688 may also be used as colorants.

Polymer particles such as matting agents and spacers, surfactants such as perfluoro-surfactants, silicon or titanium dioxide particles, colorants, metal complexing agents are well-known components of lithographic coatings.

To protect the surface of the coating, in particular from mechanical damage, a protective layer may optionally be applied on top of the coating. The protective layer generally comprises at least one water-soluble polymeric binder, such as polyvinyl alcohol, polyvinylpyrrolidone, partially hydrolyzed polyvinyl acetates, gelatin, carbohydrates or hydroxyethylcellulose. The protective layer may contain small amounts, i.e. less then 5% by weight, of organic solvents. The thickness of the protective layer is not particularly limited but preferably is up to 5.0 μm, more preferably from 0.05 to 3.0 μm, particularly preferably from 0.10 to 1.0 μm.

The lithographic printing plate precursor used in the present invention comprises a support which has a hydrophilic surface or which is provided with a hydrophilic layer. The support may be a sheet-like material such as a plate or it may be a cylindrical element such as a sleeve which can be slid around a print cylinder of a printing press. Preferably, the support is a metal support such as aluminium or stainless steel. The support can also be a laminate comprising an aluminium foil and a plastic layer, e.g. polyester film.

A particularly preferred lithographic support is an electrochemically grained and anodized aluminium support. The aluminium support has usually a thickness of about 0.1-0.6 mm. However, this thickness can be changed appropriately depending on the size of the printing plate used and/or the size of the plate-setters on which the printing plate precursors are exposed. The aluminium is preferably grained by electrochemical graining, and anodized by means of anodizing techniques employing phosphoric acid or a sulphuric acid/phosphoric acid mixture. Methods of both graining and anodization of aluminium are very well known in the art.

By graining (or roughening) the aluminium support, both the adhesion of the printing image and the wetting characteristics of the non-image areas are improved. By varying the type and/or concentration of the electrolyte and the applied voltage in the graining step, different type of grains can be obtained. The surface roughness is often expressed as arithmetical mean center-line roughness Ra (ISO 4287/1 or DIN 4762) and may vary between 0.05 and 1.5 μm. The aluminium substrate of the current invention has preferably an Ra value below 0.45 μm, more preferably below 0.40 μm, even more preferably below 0.30 μm and most preferably below 0.25 μm. The lower limit of the Ra value is preferably about 0.1 μm. More details concerning the preferred Ra values of the surface of the grained and anodized aluminum support are described in EP 1 356 926.

By anodising the aluminium support, its abrasion resistance and hydrophilic nature are improved. The microstructure as well as the thickness of the Al₂O₃ layer are determined by the anodising step, the anodic weight (g/m² Al₂O₃ formed on the aluminium surface) varies between 1 and 8 g/m². The anodic weight is preferably ≥3 g/m², more preferably ≥3.5 g/m² and most preferably ≥4.0 g/m².

The grained and anodized aluminium support may be subject to a so-called post-anodic treatment to improve the hydrophilic properties of its surface. For example, the aluminium support may be silicated by treating its surface with a sodium silicate solution at elevated temperature, e.g. 95° C. Alternatively, a phosphate treatment may be applied which involves treating the aluminium oxide surface with a phosphate solution that may further contain an inorganic fluoride.

Further, the aluminium oxide surface may be rinsed with a citric acid or citrate solution. This treatment may be carried out at room temperature or may be carried out at a slightly elevated temperature of about 30 to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulphonic acid, polyvinylbenzenesulphonic acid, sulphuric acid esters of polyvinyl alcohol, and acetals of polyvinyl alcohols formed by reaction with a sulphonated aliphatic aldehyde. It is further evident that one or more of these post-treatments may be carried out alone or in combination. More detailed descriptions of these treatments are given in GB-A 1 084 070, DE-A 4 423 140, DE-A 4 417 907, EP-A 659 909, EP-A 537 633, DE-A 4 001 466, EP-A 292 801, EP-A 291 760 and U.S. Pat. No. 4,458,005. A silicated aluminium support is particularly preferred.

The support can also be a flexible support, which may be provided with a hydrophilic layer, hereinafter called ‘base layer’. The flexible support is e.g. paper, plastic film or aluminium. Preferred examples of plastic film are polyethylene terephthalate film, polyethylene naphthalate film, cellulose acetate film, polystyrene film, polycarbonate film, etc. The plastic film support may be opaque or transparent.

The base layer is preferably a cross-linked hydrophilic layer obtained from a hydrophilic binder cross-linked with a hardening agent such as formaldehyde, glyoxal, polyisocyanate or a hydrolyzed tetra-alkylorthosilicate. The latter is particularly preferred. The thickness of the hydrophilic base layer may vary in the range of 0.2 to 25 μm and is preferably 1 to 10 μm. More details of preferred embodiments of the base layer can be found in e.g. EP-A 1 025 992.

According to the present invention there is provided a method for making a printing plate precursor comprising the steps of applying a heat and/or light sensitive coating as defined above on a lithographic support—as defined above—followed by drying said coating.

Any coating method can be used for applying the coating solution(s) to the hydrophilic surface of the support. The multi-layer coating can be applied by coating/drying each layer consecutively or by the simultaneous coating of several coating solutions at once. In the drying step, the volatile solvents are removed from the coating until the coating is self-supporting and dry to the touch. However it is not necessary (and may not even be possible) to remove all the solvent in the drying step. Indeed the residual solvent content may be regarded as an additional composition variable by means of which the composition may be optimized. Drying is typically carried out by blowing hot air onto the coating, typically at a temperature of at least 70° C., suitably 80-150° C. and especially 90-140° C. Also infrared lamps can be used. The drying time may typically be 15-600 seconds.

Between coating and drying, or after the drying step, a heat treatment and subsequent cooling may provide additional benefits, as described in WO99/21715, EP-A 1074386, EP-A 1074889, WO00/29214, and WO/04030923, WO/04030924, WO/04030925.

The heat-sensitive plate precursor can be image-wise exposed directly with heat, e.g. by means of a thermal head, or indirectly by infrared light, preferably near infrared light. The infrared light is preferably converted into heat by an IR light absorbing compound as discussed above. The printing plate precursor is positive working and relies on heat-induced solubilization of the binder of the present invention.

The printing plate precursor can be exposed to infrared light by means of e.g. LEDs or a laser. Most preferably, the light used for the exposure is a laser emitting near infrared light having a wavelength in the range from about 750 to about 1500 nm, more preferably 750 to 1100 nm, such as a semiconductor laser diode, a Nd:YAG or a Nd:YLF laser. The required laser power depends on the sensitivity of the plate precursor, the pixel dwell time of the laser beam, which is determined by the spot diameter (typical value of modern plate-setters at 1/e² of maximum intensity: 5-25 μm), the scan speed and the resolution of the exposure apparatus (i.e. the number of addressable pixels per unit of linear distance, often expressed in dots per inch or dpi; typical value: 1000-4000 dpi).

Two types of laser-exposure apparatuses are commonly used: internal (ITD) and external drum (XTD) platesetters. ITD plate-setters for thermal plates are typically characterized by a very high scan speed up to 500 m/sec and may require a laser power of several Watts. XTD platesetters for thermal plates having a typical laser power from about 200 mW to about 1 W operate at a lower scan speed, e.g. from 0.1 to 10 m/sec. An XTD platesetter equipped with one or more laserdiodes emitting in the wavelength range between 750 and 850 nm is an especially preferred embodiment for the method of the present invention.

The known platesetters can be used as an off-press exposure apparatus, which offers the benefit of reduced press down-time. XTD platesetter configurations can also be used for on-press exposure, offering the benefit of immediate registration in a multi-color press. More technical details of on-press exposure apparatuses are described in e.g. U.S. Pat. Nos. 5,174,205 and 5,163,368.

Preferred lithographic printing plate precursors according to the present invention produce a useful lithographic image upon image-wise exposure with IR-light having an energy density, measured at the surface of said precursor, of 200 mJ/cm² or less, more preferably of 180 mJ/cm² or less, most preferably of 160 mJ/cm² or less. With a useful lithographic image on the printing plate, 2% dots (at 200 lpi) are perfectly visible on at least 1000 prints on paper.

The printing plate precursor, after exposure, may be developed off-press by means of a suitable processing liquid. In the development step, the exposed areas of the image-recording layer are at least partially removed without essentially removing the non-exposed areas, i.e. without affecting the exposed areas to an extent that renders the ink-acceptance of the exposed areas unacceptable. The processing liquid can be applied to the plate e.g. by rubbing with an impregnated pad, by dipping, immersing, (spin-)coating, spraying, pouring-on, either by hand or in an automatic processing apparatus. The treatment with a processing liquid may be combined with mechanical rubbing, e.g. by a rotating brush. The developed plate precursor can, if required, be post-treated with rinse water, a suitable correcting agent or preservative as known in the art. During the development step, any water-soluble protective layer present is preferably also removed. The development is preferably carried out at temperatures of from 20 to 40° C. in automated processing units as customary in the art. More details concerning the development step can be found in for example EP 1 614 538, EP 1 614 539, EP 1 614 540 and WO2004/071767.

In one embodiment, the printing plate precursor may be developed using solvent-based or alkaline developers. Unless otherwise indicated, the amounts of developer ingredients given herein refer to the ready-to-use developer, which may be obtained by diluting a more concentrated solution that is supplied by the manufacturer.

Suitable alkaline developers for positive plates have been described in US2005/0162505. An alkaline developer is an aqueous solution which has a pH of at least 11, more typically at least 12, preferably from 12 to 14. Preferred high pH developers comprise at least one alkali metal silicate, such as lithium silicate, sodium silicate, and/or potassium silicate. Sodium silicate and potassium silicate are preferred, and potassium silicate is most preferred. A mixture of alkali metal silicates may be used if desired. Especially preferred high pH developers comprise an alkali metal silicate having a SiO₂ to M₂O weight ratio of at least of at least 0.3, in which M is the alkali metal. Preferably, the ratio is from 0.3 to 1.2. More preferably, it is from 0.6 to 1.1, and most preferably, it is from 0.7 to 1.0. The amount of alkali metal silicate in the high pH developer is typically at least 20 g of SiO₂ per 1000 g of developer (that is, at least 2 wt. %) and preferably from 20 g to 80 g of SiO₂ per 1000 g of developer (2-8 wt. %). More preferably, it is 40 g to 65 g of SiO₂ per 1000 g of developer (4-6.5 wt. %).

In addition to the alkali metal silicate, alkalinity can be provided by a suitable concentration of any suitable base, such as, for example, ammonium hydroxide, sodium hydroxide, lithium hydroxide, and/or potassium hydroxide. A preferred base is potassium hydroxide. Optional components of high pH developers are anionic, nonionic and amphoteric surfactants (up to 3% on the total composition weight), biocides (antimicrobial and/or antifungal agents), antifoaming agents or chelating agents (such as alkali gluconates), and thickening agents (water soluble or water dispersible polyhydroxy compounds such as glycerin or polyethylene glycol). However, these developers preferably do not contain organic solvents.

Solvent-based alkaline developers typically have a pH below 10.5, especially below 10.2 (measured at 25° C.). Solvent-based developers comprise water and an organic solvent or a mixture of organic solvents. They are typically free of silicates, alkali metal hydroxides, and mixtures of silicates and alkali metal hydroxides. The developer is preferably a single phase. Consequently, the organic solvent or mixture of organic solvents is preferably either miscible with water or sufficiently soluble in the developer that phase separation does not occur. Optional components include anionic, nonionic and amphoteric surfactants (up to 3% on the total composition weight), and biocides (antimicrobial and/or antifungal agents).

The following solvents and mixtures thereof are suitable for use in solvent-based developers: the reaction products of phenol with ethylene oxide (phenol ethoxylates) and with propylene oxide (phenol propoxylates), such as ethylene glycol phenyl ether (phenoxyethanol); benzyl alcohol; esters of ethylene glycol and of propylene glycol with acids having six or fewer carbon atoms, and ethers of ethylene glycol, diethylene glycol, and propylene glycol with alkyl groups having six or fewer carbon atoms, such as 2-ethoxyethanol, 2-(2-ethoxy)ethoxyethanol, and 2-butoxyethanol. A developer that comprises phenoxyethanol is preferred. The developer typically comprises 0.5 wt % to 15 wt %, preferably 3 wt % to 5 wt %, of the organic solvent or solvents, based on the weight of the developer.

A suitable alternative developer for processing positive plates comprises a non-reducing sugar and a base, as described in EP 1 403 716. The term “nonreducing sugar” means a saccharide which is free of free aldehyde or ketone group and thus is not reducing, e.g. trehalose type oligosaccharides, glycosides and sugar alcohols obtained by hydrogenating and reducing saccharides. Examples of the trehalose type oligosaccharides include saccharose, and trehalose. Examples of the glycosides include alkyl glycoside, phenol glycoside, and mustard oil glycoside. Examples of the sugar alcohols include D, L-arabitol, ribitol, xylitol, D,L-sorbitol, D,L-mannitol, D,L-iditol, D,L-talitol, dulcitol, and arodulicitol. Further, maltitol obtained by the hydrogenation of disaccharide or reduced material (reduced starch sirup) obtained by the hydrogenation of oligosaccharide may be used. Preferred among these nonreducing sugars are sugar alcohols and saccharose. Even more desirable among these nonreducing sugars are D-sorbitol, saccharose, and reduced starch sirup because they have buffer action within a proper pH range.

These nonreducing sugars may be used alone or in combination of two or more thereof. The proportion of these nonreducing sugars in the developer is preferably from 0.1 to 30% by weight, more preferably from 1 to 20% by weight.

The aforementioned nonreducing sugar may be used in combination with an alkaline agent as a base, properly selected from the group consisting of known materials such as inorganic alkaline agents, e.g. sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium hydrogencarbonate, potassium hydrogencarbonate, ammonium hydrogencarbonate, sodium borate, potassium borate and ammonium borate, potassium citrate, tripotassium citrate, and sodium citrate.

Further preferred examples of alkaline agents include organic alkaline agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine and pyridine.

These alkaline agents may be used singly or in combination of two or more thereof. Preferred among these alkaline agents are sodium hydroxide, potassium hydroxide, trisodium phosphate, tripotassium phosphate, sodium carbonate and potassium carbonate.

Another alternative silicate-free and sugar-free alkaline aqueous developer composition, as described in US2012/0129033, has a pH of at least 12 and comprises (a) a hydroxide, (b) a metal cation M2′ selected from barium, calcium, strontium, and zinc cations, (c) a chelating agent for the metal cation M+and (d) an alkali metal salt different than all of a, b, and c above.

The development step may be followed by a rinsing step and/or a gumming step. A suitable gum solution which can be used is described in for example EP-A 1 342 568 and WO 2005/111727.

In a preferred embodiment, the printing plate precursor is developed in a single step i.e. combining development and gumming. Such a gum developer has been described in EP 1 342 568 ([0010] to [0021]) and WO 2005/111727 (page 6 line 5 till page 11 line 30) and is typically an aqueous liquid which comprises one or more surface protective compounds that are capable of protecting the lithographic image of a printing plate against contamination, oxidation or damaging. Suitable examples of such compounds are film-forming hydrophilic polymers or surfactants. The layer that remains on the plate after treatment with the gum solution and drying preferably comprises between 0.1 and 20 g/m² of the surface protective compound. This layer typically remains on the plate until the plate is mounted on the press and is removed by the ink and/or fountain when the press run has been started. The gum solution preferably has a pH below 11, more preferably below 10, even more preferably a pH from 3 to 9, and most preferably from 6 to 8. After the single step development, the plate is ready to be mounted on a printing press.

The single step development may be followed by a rinsing step.

To increase the resistance of the finished printing plate and hence to extend its press life capability, the plate coating is preferably briefly heated to elevated temperatures (“baking”). The plate can be dried before baking or is dried during the baking process itself. During the baking step, the plate can be heated at a temperature which is higher than the glass transition temperature of the heat-sensitive coating, e.g. between 100° C. and 300° C. for a period of 15 seconds to 5 minutes. In a preferred embodiment, the baking temperature does not exceed 300° C. during the baking period. Baking can be done in conventional hot air ovens or by irradiation with lamps emitting in the infrared or ultraviolet spectrum, as e.g. described in EP 1 588 220 and EP 1 916 101. Both so-called static and dynamic baking ovens can be used. As a result of this baking step, the resistance of the printing plate to plate cleaners, correction agents and UV-curable printing inks increases. Such a thermal post-treatment is known in the art and is described, inter alia, in DE 1 447 963, GB 1 154 749 and EP 1 506 854. A baking gum has a similar composition as described above, with the additional preference towards compounds that do not evaporate at the usual bake temperatures. Specific examples of suitable baking gum solutions are described in e.g. EP-A 222 297, EP-A 1 025 992, DE-A 2 626 473 and U.S. Pat. No. 4,786,581.

According to the present invention there is also provided a method for making a positive-working lithographic printing plate comprising the steps of imagewise exposing the heat-sensitive lithographic printing plate precursor according to the present invention to heat and/or infrared light, followed by developing the imagewise exposed precursor with an aqueous alkaline developer and/or with a gum developer, as described above, so that the exposed areas are dissolved. The pH of the aqueous alkaline developer is preferably below 12. The obtained precursor may optionally be baked.

The printing plate thus obtained can be used for conventional, so-called wet offset printing, in which ink and an aqueous dampening liquid is supplied to the plate. Another suitable printing method uses a so-called single-fluid ink without a dampening liquid. Suitable single-fluid inks have been described in U.S. Pat. Nos. 4,045,232; 4,981,517 and 6,140,392. In a most preferred embodiment, the single-fluid ink comprises an ink phase, also called the hydrophobic or oleophilic phase, and a polyol phase as described in WO 00/32705.

### EXAMPLES

All materials used in the following examples were readily available from standard sources such as Sigma-Aldrich (Belgium) and Acros (Belgium) unless otherwise specified.

The binders used in the Examples are illustrative to the invention; their two essential monomers may be chemically modified and/or used in different molar ratio's.

### 1. Oxalylamido Binders

TABLE 1
oxalymalido binders

| | Monomer | |
|---|---|---|
| Resin | ratio % | Structure formula |
| Resin 1-1 Inv. Resin 1-2 Inv. Resin 1-3 Inv. | 9/10 80/20 60/40 | 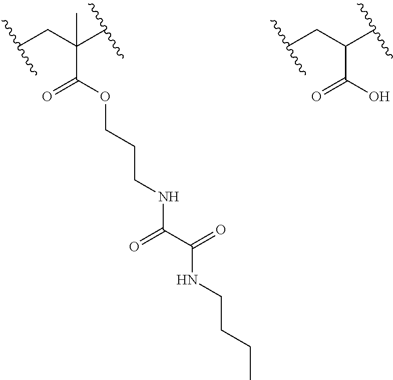 [SMILES: *CC(*)(C)C(=O)OCCCNC(=O)C(=O)NCCCC ; *CC(*)C(=O)O] |
| Resin 2-1 | 90/10 | 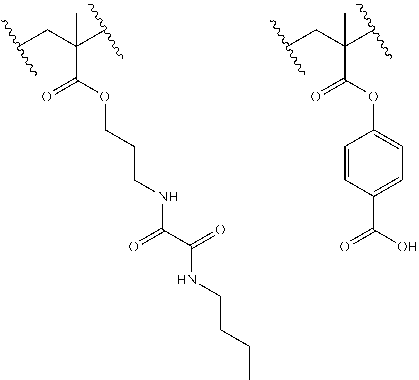 [SMILES: *CC(*)(C)C(=O)OCCCNC(=O)C(=O)NCCCC ; *CC(*)(C)C(=O)Oc1ccc(C(=O)O)cc1] |
| Resin 3-1 Inv. Resin 3-2 Inv. | 90/10 80/20 | 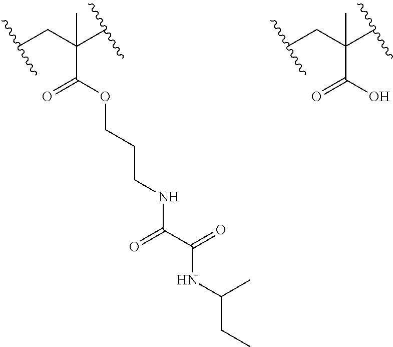 |
| Resin 4-1 | 60/40 | 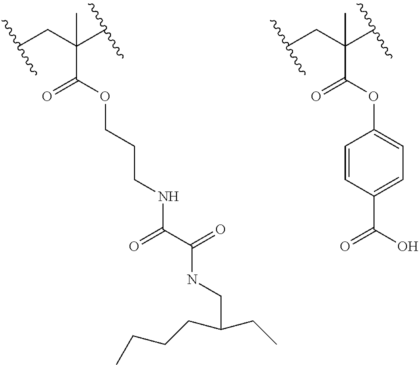 [SMILES: *CC(*)(C)C(=O)OCCCNC(=O)C(=O)NCC(CC)CCCC ; *CC(*)(C)C(=O)Oc1ccc(C(=O)O)cc1] |

### 2. Methods for Characterisation of the Binders

### LC-MS Analysis:

### a. Method 1

The LC-MS analysis was done on a HP 1100 Esquire LC, using an Altima HP C18 AQ column (150×3, 5 μm), operating at a flow rate of 0.5 ml/min and at 40° C. A gradient elution was used, with water+0.1% formic acid as eluent A and acetonitrile+0.1% formic acid as eluent B. The gradient according to table 2 was used.

TABLE 2

| Time | % B |
|---|---|
| 0 | 20 |
| 7 | 100 |
| 17 | 100 |
| 17.1 | 20 |
| 20 | 20 |

ESI ionisation was used in combination with a combibron detector. 5 μl of a solution of 2 mg of each compound in 10 ml acetonitrile was injected.

### b. Method 2

The LC-MS analysis was done on a HP 1100 Esquire LC, using an Altima HP C18 AQ column (150×3, 5 μm), operating at a flow rate of 0.5 ml/min and at 40° C. A gradient elution was used, H₂O/MeOH 9/1 containing 10 mmol NH₄OAc as eluent A and MeOH containing 10 mmol NH₄OAc as eluent B. The gradient according to table 3 was used.

TABLE 3
gradient elution

| Time | % B |
|---|---|
| 0 | 0 |
| 12 | 100 |
| 17 | 100 |
| 18 | 0 |
| 20 | 0 |

ESI ionisation was used in combination with a combibron detector. 5 μl of a solution of 2 mg of each compound in 10 ml acetonitrile was injected.

### ¹H-NMR Analysis:

A Varian Unity Inova spectrometers was used, using DMSO d6 as solvent at 25° C. with DMSO d5 (2.50 ppm) as internal reference at a spectrometer frequency of 400 MHz.

### 1. Synthesis of the Oxalylamido Monomers

### Synthesis of oxalylamido-1

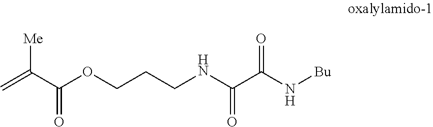

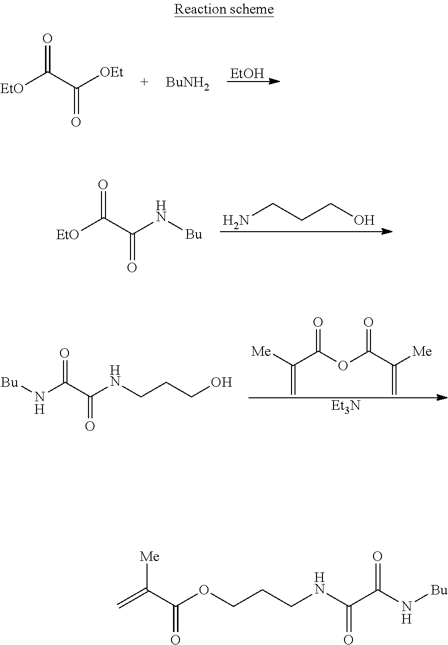

### Synthesis of the Intermediate Oxalylamide:

1.243 kg (8.5 mol) diethyl oxalate was dissolved in 4.25 l ethanol. A solution of 0.665 kg (8.96 mol) n.-butyl amine in 1.7 l ethanol was added over 80 minutes, while the temperature was kept at 0° C. The reaction was allowed to continue for an additional 30 minutes. A fraction of bis-n.butyloxalylamide was formed, which was removed by filtration. A solution of 0.638 kg (0.85 mol) 3-amino-propanol in 0.85 l ethanol was added to the ethanol solution of the mono amide over one hour while the temperature was kept below 7° C. The reaction was allowed to continue for an additional hour. The target oxalylamide was isolated by filtation, washed several times with heptane and dried. 1.354 kg of the oxalyl amide was isolated (y: 78.8%). (m.p.: 140° C., TLC analysis on Merck TLC Silicagel 60F₂₅₄ using methylene chloride/methanol 9/1 as eluent: R_{f}: 0.45).

### Synthesis of Oxalylamido-1:

5 l acetone was added to a mixture of 1012 g (5 mol) of the intermediate oxalylamide, 61 g (0.5 mol) 4-dimethylaminopyridine and 22.5 g BHT. The mixture was stirred and 1.012 kg (10 mol) triethylamine was added. The reaction mixture was heated to 50° C. and 1.23 kg (7.5 mol) methacrylic acid anhydride was added over 40 minutes, while maintaining the temperature at 50° C. The reaction was allowed to continue for an additional 20 minutes. The mixture was cooled down to room temperature. The reaction mixture was added to 10 1 water at 40° C. Oxalylamido-1 precipitated from the medium. The mixture was cooled down to room temperature and oxalylamido-1 was isolated by filtration, washed with water and dried. 1.195 kg oxalylamido-1 was isolated (y: 88.4%). (m.p.: 93° C., TLC analysis on Whatman Partisil KC18F using MeOH/0.5 M NaCl as eluent: R_{f}: 0.57).

### Synthesis of Oxalylamido-2

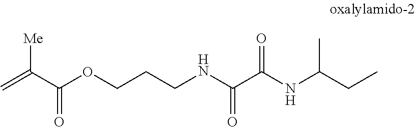 [SMILES: C=C(C)C(=O)OCCCNC(=O)C(=O)NC(C)CC]

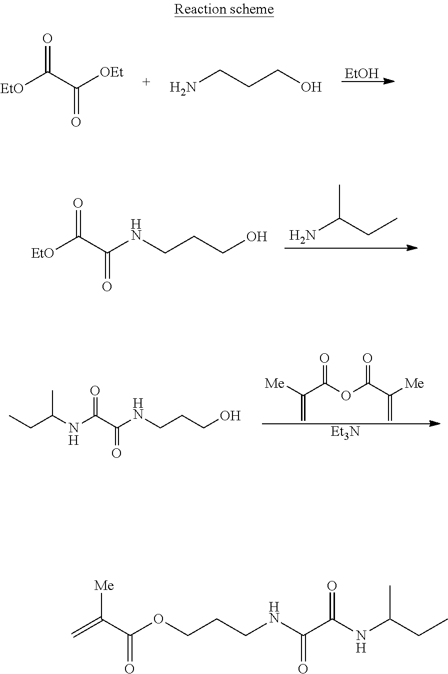

### Synthesis of the Intermediate Oxalylamide:

837 g (6 mol) diethyl oxalate was dissolved in 3 l ethanol and the mixture was cooled to 0° C. A solution of 453 g (6 mol) 3-amino-propanol in 1.2 l ethanol was added over one and a half hour, while maintaining the temperature at 0° C. The reaction was allowed to continue for one and a half hour; A small fraction of the symmetrical bisamide was formed, which was removed by filtration. A solution of 441 g (6 mol) sec.-butyl amine in 600 ml ethanol was added over one hour at 20° C. The reaction was allowed to continue at room temperature over night. The reaction mixture was heated to 40° C. and the reaction was allowed to continue for an additional 4 hours. The reaction mixture was further heated to 60° C. and the ethanol was partially removed under reduced pressure (160 to 80 mbar) until the intermediate amide precipitated from the medium as viscous suspension. The intermediate amide was isolated by filtration, washed with a small fraction ethanol and dried. 740 g (y: 61%) of the intermediate oxalylamide was isolated. (TLC analysis on Merck TLC Silicagel 60F254 using methylene chloride /methanol 9/1 as eluent: R_{f}: 0.45).

Synthesis of oxalylamido-2:

3 l acetone was added to a mixture of 606 g (3 mol) of the intermediate oxalylamide, 37.3g (0.3 mol) 4-dimethylaminopyridine and 13.5 g BHT. The mixture was stirred and 610 g (6 mol) triethylamine was added. The reaction mixture was heated to 50° C. and 738 g (4.5 mol) methacrylic acid anhydride was added over 40 minutes, while maintaining the temperature at 50° C. The reaction mixture was added to 6 l water at 50° C. The mixture was allowed to cool down to room temperature and the mixture was stirred for an additional two hours. Oxalylamide-2 was isolated by filtration, washed with water and dried. 640 g (78.9%) of oxalylamide-2 was isolated (TLC analysis on Whatman Partisil KC18F using MeOH/0.5 M NaCl as eluent: R_{f}: 0.57).

Synthesis of oxalylamido-3:

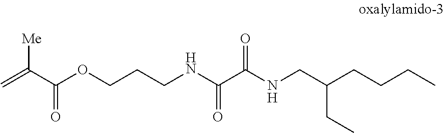 [SMILES: C=C(C)C(=O)OCCCNC(=O)C(=O)NCC(CC)CCCC]

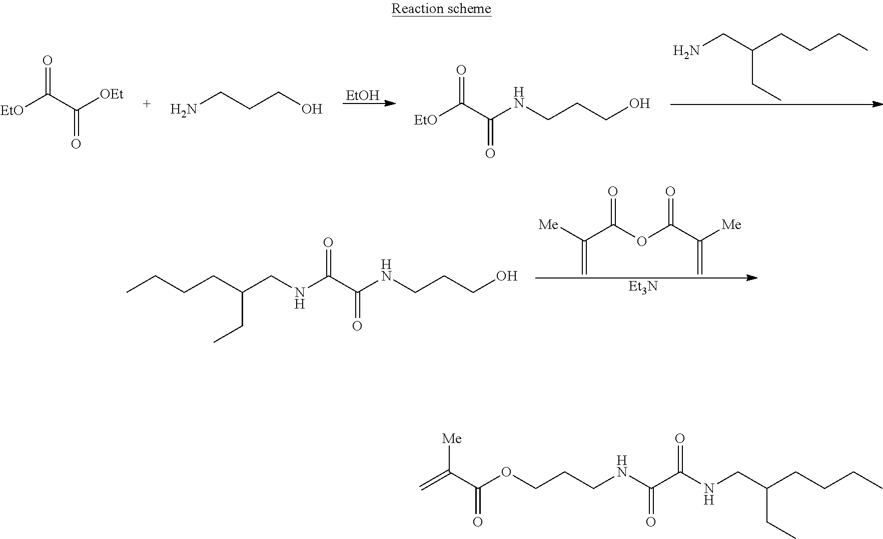

### Synthesis of the Intermediate Oxlalylamide:

815 g (5.58 mol) diethyl oxalate was dissolved in 2.8 1 ethanol and the mixture was cooled to 0° C. A solution of 419 g (5.58 mol) 3-amino-propanol in 0.55 l ethanol was added over one and a half hour, while maintaining the temperature at 0° C. The reaction was allowed to continue for one and a half hour; A small fraction of the symmetrical bisamide was formed, which was removed by filtration. A solution of 721 g (5.58 mol) 2-ethylhexyl amine in 1.1 l ethanol was added over one hour at 0° C. The reaction was allowed to continue at room temperature over night. The reaction mixture was added to 17 l water at 40° C. The reaction mixture was allowed to cool down to room temperature and the intermediate oxalylamide was isolated by filtration, washed with water and dried. 1075 g (y: 75%) of the intermediate oxalylamide was isolated. (TLC analysis on Merck TLC Silicagel 60F254 using methylene chloride/methanol 9/1 as eluent: R_{f}: 0.57).

Synthesis of oxalylamide-3:

2.5 l acetone was added to a mixture of 646 g (2.5 mol) of the intermediate oxalylamide, 30.6 g (0.25 mol) 4-dimethylaminopyridine and 11 g BHT. The mixture was stirred and 505 g (5 mol) triethylamine was added. The reaction mixture was heated to 50° C. and 615 g (3.75 mol) methacrylic acid anhydride was added over 40 minutes, while maintaining the temperature at 50° C. The reaction was allowed to continue for 20 minutes at 50° C. The reaction mixture was cooled down to room temperature and added to 5 l water at 40° C. The mixture was cooled down to room temperature and stirred for an additional hour. Oxalylamide-3 was isolated by filtration, washed with water and dried. 746 g (91.4%) of oxalylamide-3 was isolated (TLC analysis on Whatman Partisil KC18F using MeOH/0.5 M NaCl as eluent: R_{f}: 0.57).

### p-Methacryloyloxybenzoic Acid

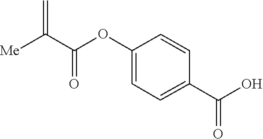

p-Methacryloyloxybenzoic acid was prepared as disclosed by Van Ekenstein and Tan (Eur. Polym. J., 31(3), 239-242 (1995)).

### 1. Synthesis of the Oxalylamido Binders

### Copolymers of oxalylamido-1 and Acrylic Acid (Resin 1-1, Resin 1-2, Resin 1-3)

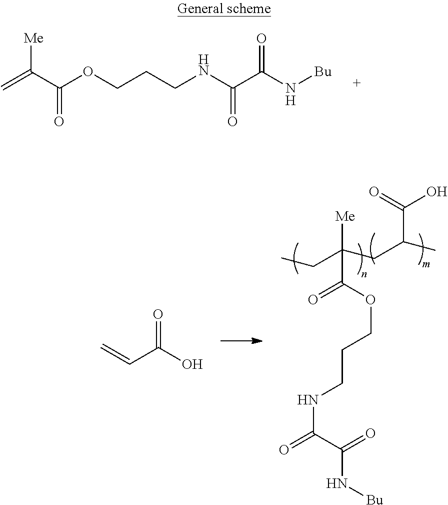

x g of oxalylamido-1 and y g of acrylic acid (table 1) were dissolved in 30 g γ-butyrolactone. A gentle nitrogen flow was put over the reactor. The mixture was stirred at 200 rpm and heated to 105° C. After complete dissolution of the monomers, 58 μl trigonox DC50 was added immediately followed by the addition of 0.804 ml of a 25 w % solution of Trigonox 141 in γ-butyrolactone. The polymerisation was exothermic. When the reaction temperature started to decrease back to 105° C., 291 μl Trigonox DC50 was added and the reaction temperature was increased to 130° C. The polymerisation was allowed to continue at 130° C. for two hours. The stirrer speed was increased to 400 rpm and the reaction mixture was cooled to 120° C. 14.1 ml 1-methoxy-2-propanol was added and the reaction mixture was allowed to cool down to room temperature. The solution of the polymer was directly used to coat lithographic printing plate precursors, without isolating the polymer.

TABLE 4

| | Oxalylamido-1 | Acrylic acid |
|---|---|---|
| | g | g |
| Resin 1-1 | 12.2 | 0.4 |
| Inv. | | |
| Resin 1-2 | 10.8 | 0.7 |
| Inv. | | |
| Resin 1-3 | 8.1 | 1.4 |
| Inv. | | |

### Copolymers of oxalylamido-1 and p-methacryloyloxybenzoic Acid (Resin 2-1)

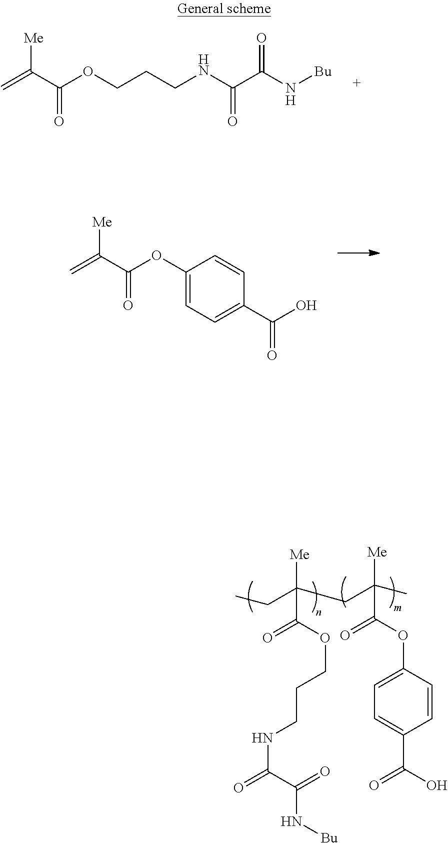

12.2 g of oxalylamido-1 and 1.0 g of p.-methacryloyloxybenzoic acid were dissolved in 30 g γ-butyrolactone. A gentle nitrogen flow was put over the reactor. The mixture was stirred at 200 rpm and heated to 105° C. After complete dissolution of the monomers, 58 μl trigonox DC50 was added immediately followed by the addition of 0.804 ml of a 25 w % solution of Trigonox 141 in γ-butyrolactone. The polymerisation was exothermic. When the reaction temperature started to decrease back to 105° C., 291 μl Trigonox DC50 was added and the reaction temperature was increased to 130° C. The polymerisation was allowed to continue at 130° C. for two hours. The stirrer speed was increased to 400 rpm and the reaction mixture was cooled to 120° C. 14.1 ml 1-methoxy-2-propanol was added and the reaction mixture was allowed to cool down to room temperature. The solution of the polymer was directly used to coat lithographic printing plate precursors, without isolating the polymer.

### Copolymers of oxalylammido-2 and Acrylic Acid (Resin 3-1, Resin 3-2)

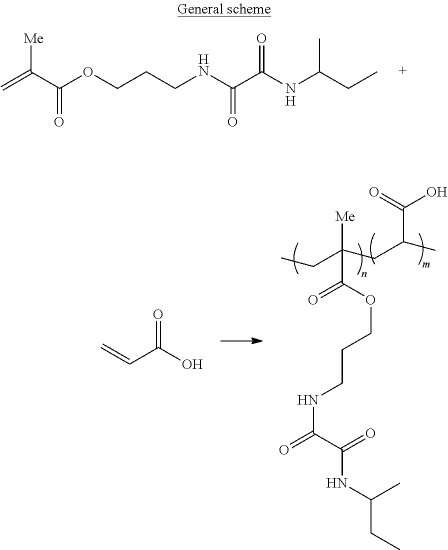

x g of oxalylamido-2 and y g of acrylic acid (table 2) were dissolved in 30 g γ-butyrolactone. A gentle nitrogen flow was put over the reactor. The mixture was stirred at 200 rpm and heated to 105° C. After complete dissolution of the monomers, 58 μl trigonox DC50 was added immediately followed by the addition of 0.804 ml of a 25 w % solution of Trigonox 141 in γ-butyrolactone. The polymerisation was exothermic. When the reaction temperature started to decrease back to 105° C., 291 μl Trigonox DC50 was added and the reaction temperature was increased to 130° C. The polymerisation was allowed to continue at 130° C. for two hours. The stirrer speed was increased to 400 rpm and the reaction mixture was cooled to 120° C. 14.1 ml 1-methoxy-2-propanol was added and the reaction mixture was allowed to cool down to room temperature. The solution of the polymer was directly used to coat lithographic printing plate precursors, without isolating the polymer.

TABLE 5

| | Oxalylamido-2 | Acrylic acid |
|---|---|---|
| | g | g |
| Resin 3-1 | 12.2 | 0.4 |
| Inv. | | |
| Resin 3-2 | 10.8 | 0.7 |
| Inv. | | |

### Copolymers of oxalylamido-3 and p-methacryloyloxybenzoic Acid ( Resin 4-1)

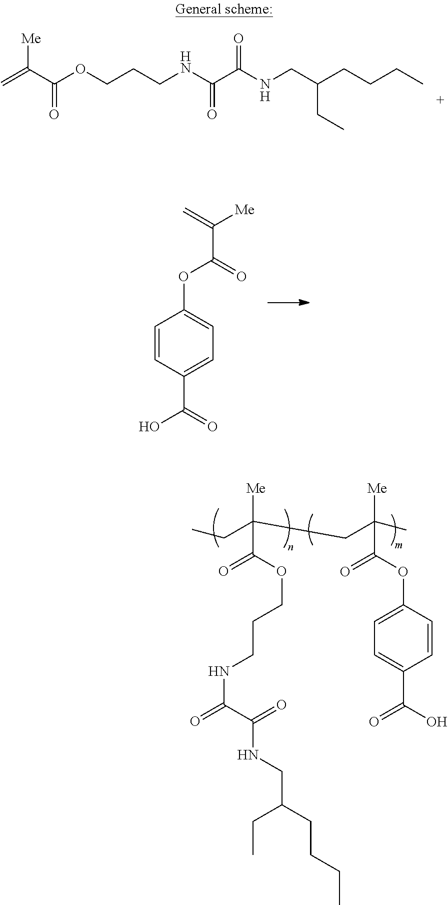

9.8 g of oxalylamido-3 and 4.1 g of p.-methacryloyloxybenzoic acid were dissolved in 30 g γ-butyrolactone. A gentle nitrogen flow was put over the reactor. The mixture was stirred at 200 rpm and heated to 105° C. After complete dissolution of the monomers, 58 μl trigonox DC50 was added immediately followed by the addition of 0.804 ml of a 25 w % solution of Trigonox 141 in γ-butyrolactone. The polymerisation was exothermic. When the reaction temperature started to decrease back to 105° C., 291 μl Trigonox DC50 was added and the reaction temperature was increased to 130° C. The polymerisation was allowed to continue at 130° C. for two hours. The stirrer speed was increased to 400 rpm and the reaction mixture was cooled to 120° C. 14.1 ml 1-methoxy-2-propanol was added and the reaction mixture was allowed to cool down to room temperature. The solution of the polymer was directly used to coat lithographic printing plate precursors, without isolating the polymer.

### 1. Preparation of the Printing Plate Precursors

### Preparation of the Support S-01

A 0.3 mm thick aluminium plate was degreased by spraying with an aqueous solution containing 34 g/l NaOH at 70° C. for 6 seconds and rinsed with demineralised water for 3.6 seconds. The foil was then electrochemically grained during 8 seconds using an alternating current in an aqueous solution containing 15 g/l HCl, 15 g/l SO₄²⁻ ions and 5 g/l Al³⁺ ions at a temperature of 37° C. and a current density of about 100 A/dm² (charge density of about 800 C/dm²). Afterwards, the aluminium foil was desmutted by etching with an aqueous solution containing 6.5 g/l of sodium hydroxide at 35° C. for 5 seconds and rinsed with demineralised water for 4 seconds. The foil was subsequently subjected to anodic oxidation during 10 seconds in an aqueous solution containing 145 g/l of sulfuric acid at a temperature of 57° C. and an anodic charge of 250 C/dm², then washed with demineralised water for 7 seconds and dried at 120° C. for 7 seconds.

The support thus obtained (support S-00) was characterised by a surface roughness Rₐ of 0.45-0.50 μm (measured with interferometer NT3300 and had an anodic weight of about 3.0 g/m² (gravimetric analysis).

The support S-01 was produced by spraying, onto the above described support S-00, a post treatment solution containing 2.2 g/l polyvinylphosphonic acid (PVPA) for 4 seconds at 70° C., rinsed with demineralised water for 3.5 seconds and dried at 120° C. for 7 seconds.

### Preparation of the Printing Plate Precursors

A 50 g coating solution was prepared by mixing the components as described in Table 6. Each coating solution was coated onto the lithographic support S-01 by means of a semi-automated coating device in a wet-layer thickness of 26 μm. The coating was dried for 1 min at 100° C. After drying, the sample was exposed to a hot-warehouse treatment for two days, at 55° C. and 25% relative humidity. The printing plate precursors PPP-01 to PPP-03 were obtained (see Table 7).

TABLE 6
Ingredients of the coating solution

| | Ingredients g |
|---|---|
| Binder (1) | 13.47 |
| IR dye (2) | 6.00 |
| Contrast dye (3) | 5.35 |
| Megaface F-253 (4) | 0.020 |
| MEK | 16.22 |
| THF | 8.94 |
| Total coating solution | 50 |

(1) See Table 1;
(2) Infrared cyanine dye, commercially available from FEW CHEMICALS having the following chemical structure: 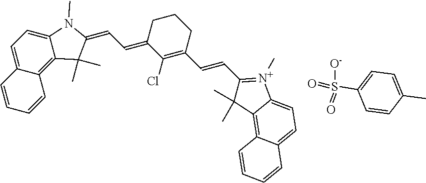 [SMILES: CN1/C(=C/C=C2\CCCC(/C=C/C3=[N+](C)c4ccc5ccccc5c4C3(C)C)=C2Cl)C(C)(C)c2c1ccc1ccccc21 ; Cc1ccc(S(=O)(=O)[O-])cc1]
(3) Solution in 1-methoxy-2-propanol of 1% by weight of Crystal Violet, commercially available from Ciba-Geigy GmbH.;
(4) Fluorinated acrylic copolymer, commercially available from DIC with the following chemical structure:

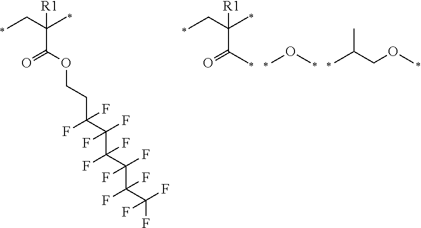

TABLE 7
printing plate precursors PPP-01 to PPP-04

| Number printing | |
|---|---|
| plate precursor | Binder |
| PPP-01 | Resin 1-2 |
| inventive | |
| PPP-02 | Resin 3-2 |
| inventive | |
| PPP-03 | Resin 4-1 |
| inventive | |
| PPP-04 | Resin 1-3 |
| inventive | |

### Exposure

The printing plate precursors were imagewise exposed at a range of energy densities (80-200 mJ/cm²) with a Creo Trendsetter, a platesetter having a 20 W infrared laser head (830 nm), operating at 140 rpm and 2400 dpi, commercially available from Eastman Kodak Corp. The image had a 50% dot coverage and consisted of a 10 μm×10 μm checkerboard pattern.

### Alkaline Development

200 ml of the developer DEV-01 as defined in Table 8 was put in a cylindrical container which was placed in an incubator at 25° C. The exposed printing plate precursors PPP-01 to PPP-03 were brought into the container during a developer dwell time of 25 seconds. After removal, the obtained printing plates PP-01 to PP-03 were thoroughly rinsed with water at room temperature.

TABLE 8
composition of the developer solution DEV-01 (1)

| | Amount |
|---|---|
| Ingredient | g/1 |
| 1M phosphate buffer at pH 11.4 | 895.05 |
| Ralufon DCH (2) | 50 |
| 2-amino-2-methyl-1-propanol | 15 |
| Proxel ultra 5 (3) | 1.3 |
| Servoxyl VPNZ 9/100 (4) | 21 |
| SAG220 (5) | 0.05 |
| Bayhibit AM (50%) (6) | 17.6 |

(1) The pH of the developer is 10 and the conductivity 7.24 mS/cm +/− 0.1 mS/cm (measured at 20° C.). The pH is adjusted to the target value by using potassium hydroxide. The ingredients are added to demineralized water (total 1 1);
(2) Ralufon DCH is commercially available from Raschig and has the following chemical structure: 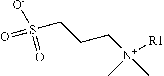
R1 = cocoalkyl containing +/− 53% C12:
(3) Biocide, commercially available from Avecia; 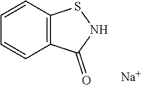
(4) a phosphonated surfactant, a mixture of mono-and diphosphonated components with tridecyl branched hydrophobic chains, commercially available from Condea Servo BV.
(5) SAG220 Anti-Foam Emulsion, polydimethylsiloxane emulsion in water (20 wt % active material), commercially available from Momentive Performance Materials Inc.;
(6) Bayhibit AM, sequestering agent commercially available from Bayer AG. with the following structure:

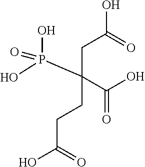 [SMILES: O=C(O)CCC(CC(=O)O)(C(=O)O)P(=O)(O)O]

### Contrast Evaluation

The contrast between the image and non-image areas was determined after development in the developer DEV-01 and is defined as the difference in optical density between the exposed and non-exposed areas. The contrast was evaluated visually.

A clear contrast was obtained in DEV-01 for the printing plates PP-01 to PP-03.

### Gum Development

The exposed printing plate precursor PPP-04 (see above) was developed as described above using the gum developer solution DEV-02 defined in Table 9. No further gumming and/or rinsing step were performed, i.e. a single step processing. Printing plate PP-04 was obtained.

TABLE 9
composition of the gum developer DEV-02 (1)

| | Amount |
|---|---|
| Ingredient | g/1 |
| TRIS buffer (2) | 9.68 |
| Corn dextrine (3) | 80 |
| Ralufon DCH (4) | 2 |

(1) The pH of the developer is 9.9; the ingredients are added to demineralized water (total 1 1);
(2) Tris (hydroxymethyl) aminomethane; commercially available from Merck;
(3) Glucidex 12IT, maltodextrine, thickener commercially available from Barentz NV;
(4) Ralufon DCH is commercially available from Raschig and has the following chemical structure: 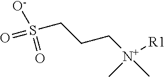
R1 = cocoalkyl containing +/− 53% C12:

### Contrast Evaluation

The printing plate PP-04 developed in DEV-02 was mounted on a Heidelberg GTO 52 printing press (available from Heidelberg). Each print job was started using K+E Novavit 800 Skinnex ink (trademark of BASF Druckfarben GmbH)and 2 wt % Prima FS404 (trademark of Agfa Graphics NV) in water as fountain solution. A compressible blanket was used and printing was performed on non-coated offset paper.

An excellent contrast between the image and non-image areas was obtained on paper after printing 25 pages. The contrast is defined as the difference in optical density between the exposed areas and non-exposed areas and is evaluated herein visually.

The results of the print test confirm that printing plates including the binder according to the present invention can be processed using a mild developer, for example based on corn dextrin.

### Chemical Resistance Evaluation

Several samples were coated by means of a home-made coating device next to each other on the aluminium support S-01 as described above.

Seven different oxalylamido binders (see Table 1) were coated (coating solution see Table 6) at a comparable layer thickness (1-2 μm dry coating thickness) next to each other on the substrate in random order. Samples SA-01 to SA-07 were obtained (see Table 10).

TABLE 10
Samples SA-01 to SA-07

| Samples | Binder |
|---|---|
| SA-01 | Resin 1-1 |
| inventive | |
| SA-02 | Resin 1-2 |
| inventive | |
| SA-03 | Resin 1-3 |
| inventive | |
| SA-04 | Resin 2-1 |
| inventive | |
| SA-05 | Resin 3-1 |
| inventive | |
| SA-06 | Resin 3-2 |
| inventive | |
| SA-07 | Resin 4-1 |
| inventive | |

Strips of these samples SA-01 to SA-07 were put on a Drent web offset printing press, using newspaper stock 45 g/m² (from Stora Enso) and Sun Chemical Magenta UV ink. As such a 7×7 matrix of the seven binders was printed up to 10000 sheets.

The samples SA-01 to SA-07 all showed an excellent ink acceptance during the entire print test.

The solvent or chemical resistance was evaluated as follows:

The samples SA-01 to SA-07 were exposed to a droplet (50 μl) of 20 different pressroom chemicals or ingredients of pressroom chemicals, for 1 min at room temperature. The chemicals are removed with a cotton pad. The damage to the coating was visually evaluated and scored between 0 and 5. The degree of damage the chemical had induced to the coating was visually evaluated and scored with a value ranging between 0 and 5:

0=no coating damage;
1=minor coating damage;
2=some coating damage;
3=a lot of coating damage;
4=severe coating damage;
5=complete dissolution of the coating.

The obtained values for each different chemical are added and the sum gives an indication of the chemical resistance: the higher the number, the lower the chemical resistance of the sample.

The set of chemicals to which the samples were exposed is presented in the tables below.

TABLE 11
fountain solutions

| Fountain solutions | Commercially available from |
|---|---|
| 3520 Emerald Premium | Anchor |
| Prisco 3551 + 2 | Prisco Europe Bvba |
| Prisco 3551 + 2 (50% w/w) | Prisco Europe Bvba |
| Varn Fount 2000 | Varn Products |
| Prisco Webfount 225^{E} | Prisco Europe Bvba |
| Prisco Webfount 230^{E} | Prisco Europe Bvba |
| Antura FS707 web | Agfa Graphics NV |
| Isopropanol | Acros or Aldrich |
| Prisco 2351 | Prisco Europe Bvba |

TABLE 12
wash solutions

| Wash solutions | Commercially available from |
|---|---|
| Methoxypropanol | Acros |
| Solco Solstar 4065 E | Solco OffsetProducts NV |
| Wash 228 | Anchor |
| Antura Wash UV74A | Agfa Graphics NV |
| UV Wash CBR silverwash | Ampla Polygrafia |
| UV LO (25% w/w) | |

TABLE 13
plate cleaners

| Plate cleaners | Commercially available from |
|---|---|
| Normakleen RC910 | Agfa Graphics NV |
| Forta Kleen Ultra | Agfa Graphics NV |
| LPC Plate cleaner | Tower Products |

TABLE 14
plate correctors

| Plate cleaners | Commercially available from |
|---|---|
| Reviva Plate | Agfa Graphics NV |
| Reviva Corrector | Agfa Graphics NV |
| pen CIF-B | |

The results in Table 15 show that the chemical resistance of the samples including an oxalylamido binder is comparable to the reference Thermostar P970, commercially available from Agfa Graphics NV.

TABLE 15
Chemical resistance of the samples SA-01 to SA-07

| Samples | Chemical resistance |
|---|---|
| Reference* | 60 |
| SA-01 | 59 |
| Inventive | |
| SA-02 | 58 |
| Inventive | |
| SA-03 | 61 |
| inventive | |
| SA-04 | 58 |
| inventive | |
| SA-05 | 46 |
| inventive | |
| SA-06 | 48 |
| inventive | |
| SA-07 | 59 |
| inventive | |

*Thermostar P970, commercially available from Agfa Graphics NV.

1-10. (canceled)

11. A positive-working lithographic printing plate precursor comprising:
a support including a hydrophilic surface or a hydrophilic layer; and
a heat and/or light-sensitive coating on the support and including an infrared absorbing agent and a binder including a monomeric unit including an oxalylamide moiety and a monomeric unit including a solubility enhancing group.

12. The printing plate precursor according to claim 11, wherein the monomeric unit including the oxalylamide moiety is represented by structure I: 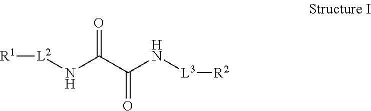
wherein
R¹ represents a group including a free radical polymerizable group;
R² represents a terminal group; and
L² and L³ independently represent a divalent linking group.

13. The printing plate precursor according to claim 12, wherein the terminal group R² is selected from the group consisting of hydrogen, an optionally substituted alkyl or cycloalkyl group, an optionally substituted aryl group, an optionally substituted aralkyl group, or an optionally substituted heteroaryl group.

14. The printing plate precursor according to claim 11, wherein the solubility enhancing group has a pKa below 10.

15. The printing plate precursor according to claim 11, wherein the solubility enhancing group is selected from the group consisting of a carboxylic group, a sulfonic acid group, an imide group, a phosphonic acid group, a sulfuric acid mono ester group, and/or a phosphoric acid mono- or di-ester.

16. The printing plate precursor according to claim 11, wherein the binder includes at least 10 mol % of the monomeric unit including the solubility enhancing group.

17. A method for making the positive-working lithographic printing plate precursor according to claim 11, the method comprising the steps of:
applying on the support the heat and/or light-sensitive coating ; and
drying the heat and/or light-sensitive coating.

18. A method for making the positive-working lithographic printing plate according to claim 11, the method comprising the steps of:
imagewise exposing the heat-sensitive lithographic printing plate precursor to heat and/or infrared light; and
developing the imagewise exposed heat-sensitive lithographic printing plate precursor with an aqueous alkaline developer.

19. A method for making the positive-working lithographic printing plate according to claim 11, the method comprising the steps of:
imagewise exposing the heat-sensitive lithographic printing plate precursor to heat and/or infrared light; and
developing the imagewise exposed heat-sensitive lithographic printing plate precursor in a single step with a gum developer.

20. The method of printing according to claim 19, wherein the gum developer has a pH below 11.
